(19) United States
(12) Patent Application Publication
(10) Pub. No.: US 2005/0046217 A1
(43) Pub. Date: Mar. 3, 2005

(54) DASHMAT WITH COMPONENT GAP SEAL

(75) Inventor: Michael T. Campbell, Grand Rapids, MI (US)

Correspondence Address: MCGARRY BAIR PC, 171 MONROE AVENUE, N.W., SUITE 600, GRAND RAPIDS, MI, 49503, US

(73) Assignee: CASCADE ENGINEERING, INC., Grand Rapids, MI (US)

(21) Appl. No.: 10/711,122

(22) Filed: Aug. 25, 2004

Related U.S. Application Data
(60) Provisional application No. 60/481,286, filed on Aug. 25, 2003.

(51) Int. Cl. B62D 33/00

(52) U.S. Cl. 296/39.3

(57) ABSTRACT

The invention comprises an acoustic seal to reduce the amount of noise entering a passenger compartment of a vehicle through apertures in a firewall and an overlying dashmat through which conduits extend. In particular, the acoustic absorber extends from the dashmat to a vehicle component to envelop the space around a conduit passing from the engine compartment through the firewall to the component. The acoustic seal comprises an outer sound barrier layer overlying an inner sound absorbing layer.

### CROSS-REFERENCE TO RELATED APPLICATION

This application claims the benefit of U.S. provisional application Ser. No. 60/481,286, filed Aug. 25, 2003, which is incorporated herein by reference in its entirety.

### FIELD OF THE INVENTION

This invention relates to a vehicle dashmat with an acoustic seal. In one of its aspects, the invention relates to a vehicle with a dashmat that has an improved acoustic seal for reducing transmission of noise through an opening in the vehicle firewall and the dashmat and from the engine compartment of a vehicle into the passenger compartment. In another of its aspects, the invention relates to a dashmat having an improved acoustic seal for an opening in the dashmat.

### DESCRIPTION OF THE RELATED ART

Motor vehicles have a steel firewall between the engine compartment and the passenger compartment. It has been a common practice in the automotive industry to employ an acoustic barrier system between the firewall and the passenger compartment of the vehicle to reduce noise from the engine compartment into the passenger compartment. FIG. 1 illustrates an example of a prior art firewall 10 separating an engine compartment 11 from a passenger compartment 15, with a noise-reducing dashmat 12 placed along the passenger compartment side of the firewall 10. The dashmat 12 generally comprises a relatively dense, resilient barrier layer 13 that reflects sound back toward its source, and a foam or fiber sound-absorbing material 14 intermediate the firewall 12 and the barrier layer 13.

Various components 16 can be installed in the passenger compartment 1 over the dashmat 12. Apertures 19, 17 through the firewall 10 and dashmat 12, respectively are provided for conduits 18 used to convey fluids and/or electrical power to and from the components 16. As shown in FIG. 1, moisture seals 20 are used to fill any space between the conduits 18 and the apertures 17, 19 to prevent water or other materials from entering the passenger compartment 15 and, to a lesser extent, reduce the amount of noise entering the passenger compartment 15. The seal 20 can be made of a moisture-impermeable foam, such as expanded polyurethane or foam rubber. However, noise from the engine compartment 11 can pass through the foam seal 20, which is a relatively weak acoustic barrier, and along a path, such as the sound path 22 illustrated in FIG. 1, between the automotive component 16 and the dashmat 12, into the passenger compartment. The primary purpose of the seal 20 is to provide moisture and debris sealing, with acoustic barrier properties being of secondary importance.

U.S. Pat. No. 5,975,609 to Campbell discloses a boot for acoustically sealing a steering column, which is integrally molded with a dashmat attached to a motor vehicle firewall. The boot comprises a single-layer sound barrier having a flexible configuration for accommodating the steering column.

U.S. Pat. No. 6,070,928 to Campbell discloses a dashmat having a pair of opposed, cooperative doors integrated therein in register with openings in the dashmat and an underlying firewall for acoustically sealing a conduit extending through the openings.

An acoustic barrier designed to block the transmission of sound through a firewall aperture into the passenger compartment is disclosed in U.S. Pat. No. 5,557,078 to Holwerda. Holwerda '078 discloses a dashmat having a pass-through aperture circumscribed by an inwardly-extending, flexible, flap-type seal which engages the periphery of a pass-through component.

### SUMMARY OF THE INVENTION

In a motor vehicle that includes an engine compartment and a passenger compartment that are separated by a firewall containing at least one opening therethrough for passage of a conduit. A sound attenuating dashmat is mounted to the firewall along the passenger compartment side and has an opening in registry with the at least one opening in the firewall. A vehicle component is mounted to the firewall in the passenger compartment adjacent the openings in the firewall and the dashmat and may communicate with the conduit. An acoustic seal according to the invention surrounds the openings in the firewall and the dashmat and extends upwardly from an upper surface of the dashmat toward the passenger compartment, the acoustic seal having sound absorbing and sound barrier components to attenuate sound that passes through the openings in the firewall and the dashmat and above the upper surface of the dashmat so that the acoustic seal interrupts the transmission of sound from the engine compartment into the passenger compartment of the motor vehicle.

The acoustic seal further comprises an upwardly extending side wall and a top wall of a sound barrier material. The sound barrier material comprises a dense, resilient, flexible synthetic resin, such as a filled thermoplastic elastomer, an unfilled thermoplastic elastomer, an elastomer-modified polyurethane, a thermoset plastic, a polyurethane, or a thermoplastic. The acoustic seal side wall can be integrally formed with the sound barrier of the dashmat, or can be formed separately from the sound barrier of the dashmat.

The acoustic seal further comprises a sound absorber material comprising a low density, porous material, such as expanded flexible polyurethane, a flexible fibrous material, a non-woven glass fiber mat, or shoddy cotton. The sound absorber material can have a central opening for passage of the conduit and can be in the shape of an annular body that is integrally formed with the sound absorbing layer of the dashmat. Alternatively, acoustic seal sound absorber material can be formed separately from the sound absorbing layer of the dashmat and fastened to the sound absorbing layer.

The dashmat comprises a barrier layer and a sound absorbing layer. The barrier layer comprises a dense, resilient, flexible synthetic resin, such as barium sulfate filled polypropylene, a thermoplastic elastomer, an elastomer-modified polyurethane, a thermoset plastic, a polyurethane, or a filled thermoplastic. The sound absorbing layer comprises a foam plastic, such as an expanded flexible polyurethane, a flexible fibrous material, a nonwoven glass fiber mat, or a shoddy cotton.

The acoustic seal can be in contact with the vehicle component when the vehicle component is mounted to the firewall.

Further according to the invention, a dashmat for mounting in a vehicle firewall that separates an engine compartment from a passenger compartment and wherein the firewall has at least one opening for passage of a conduit therethrough, has an acoustic seal that surrounds an opening the dashmat. The acoustic seal surrounds the opening in the dashmat and extends upwardly from an upper surface of the dashmat. The acoustic seal has sound absorbing and sound barrier components to attenuate sound that may pass through the openings in the firewall and the dashmat and above the upper surface of the dashmat when the dashmat is mounted to the firewall to thereby attenuate the transmission of sound through the opening in the dashmat.

Still further according to the invention, an acoustic seal for surrounding an opening in a substrate having an obverse surface and a reverse surface has a collar that is mounted on the obverse surface, surrounds the opening and has sound absorbing and sound barrier components to attenuate sound that passes through the opening in the substrate. The acoustic seal extends generally perpendicular from the obverse surface of the substrate. The acoustic seal interrupts the transmission of sound through the opening in the substrate from the reverse side to the obverse side of the substrate.

### BRIEF DESCRIPTION OF THE DRAWINGS

FIG. 1 is a schematic cross-sectional view of a prior art assembly comprising a pass-through component mounted to a motor vehicle firewall separating an engine compartment from a passenger compartment and showing a sound path from the engine compartment to the passenger compartment.

FIG. 2 is an exploded view from the passenger compartment of the motor vehicle of a portion of the firewall, the pass-through component, and an acoustic seal according to the invention.

FIG. 3 is a schematic cross-sectional view similar to the view illustrated in FIG. 1 of the pass-through component mounted to the firewall with the acoustic seal illustrated in FIG. 2.

FIG. 4 is a close-up perspective view of the component with an attached conduit and the acoustic seal illustrated in FIG. 1.

FIG. 5 is a cross-sectional view of a portion of the conduit and the acoustic seal illustrated in FIG. 4 taken along view line 5-5.

FIG. 6 is a cross-sectional view similar to that illustrated in FIG. 5 of a second embodiment of the acoustic seal.

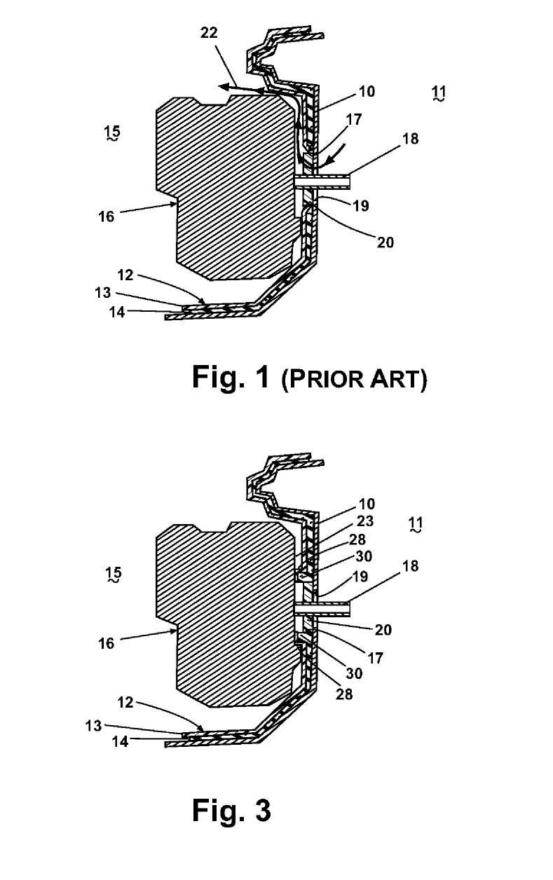

### DESCRIPTION OF AN EMBODIMENT OF THE INVENTION

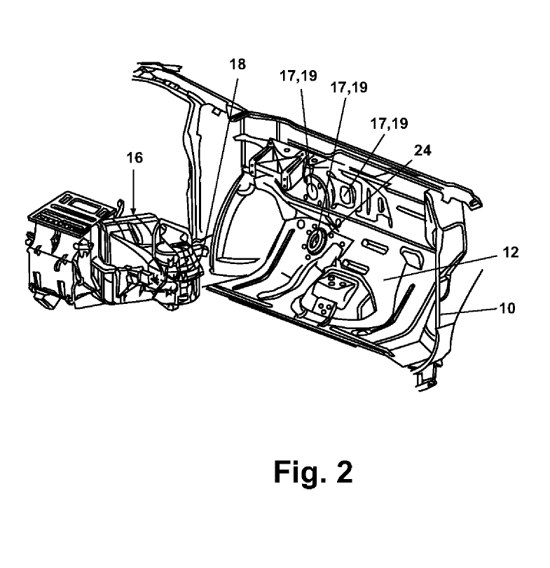

Referring now to the drawings and to FIGS. 2 and 3 in particular, a generally conventional firewall 10 separates an engine compartment 11 from a passenger compartment 15 of a vehicle. The inventive acoustic barrier system described herein shares several elements of the prior art acoustic barrier system described previously. Thus, like identifying numerals will be given to like elements shared by the prior art and the invention. The firewall 10 has a number of openings 19 therethrough (only one of which is shown in FIG. 3). The view in FIG. 2 is from the passenger compartment. It should be noted that the invention is illustrated in the context of a vehicle firewall for exemplary purposes only, and that the invention is not limited by the examples described herein. In particular, the invention is not limited to use with a two-layer dashmat described herein, but can be used with any dashmat that has both barrier and absorption properties, including single layer firm-flexible foam. An example of a firm flexible foam suitable for a dashmat is described in International Publication No. WO 2004/062966 A2, published Jul. 29, 2004, and entitled “Molded Lightweight Foam Acoustical Barrier And Method Of Making Same,” which is incorporated by reference as though set forth fully herein. In fact, the acoustic seal can be used to attenuate sound through any opening in a substrate, regardless of the nature of the substrate.

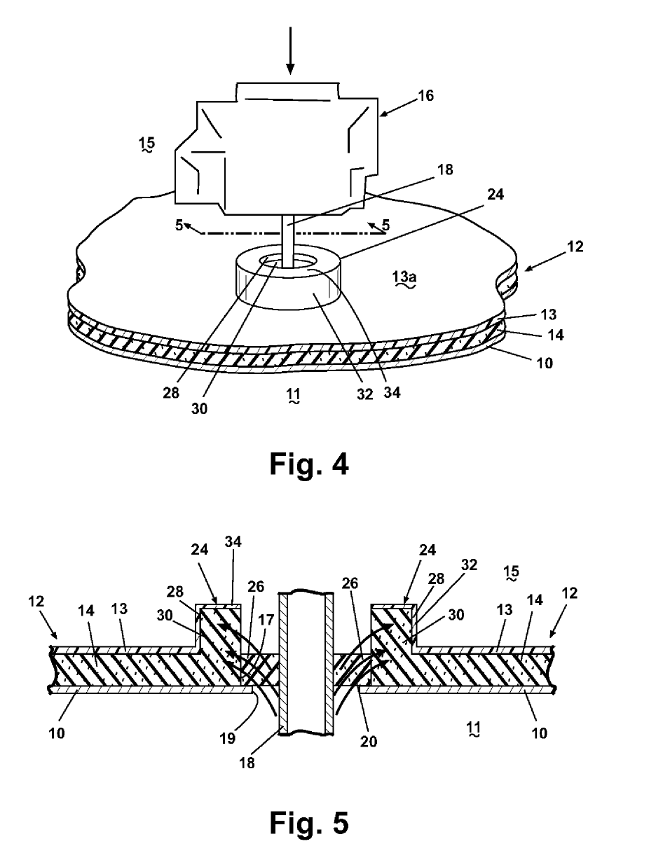

A dashmat 12 is located along the passenger compartment side of the firewall 10 and comprises a barrier layer 13 and a sound absorbing layer 14. The barrier layer 13 has an upper surface 13a facing the passenger compartment, as illustrated in FIG. 4. The barrier layer 13 and the sound absorbing layer 14 have an opening 17 therethrough. The barrier layer 13 is typically made of a relatively dense, resilient or flexible synthetic polymer, such as a barium sulfate filled polypropylene, a thermoplastic elastomer, elastomer-modified polyurethanes, thermosets such as polyurethanes, or other filled thermoplastic materials. The sound absorbing layer 14 is typically a foam material, such as expanded flexible polyurethane, or a flexible fibrous material, such as a nonwoven glass fiber mat, shoddy cotton, or other relatively low density, porous sound-absorbing material that is commonly employed to absorb sound and/or act as a decoupling layer in an acoustic barrier assembly. The sound absorbing layer 14 is typically bonded to the barrier layer 13 so that it is interposed between the barrier layer 13 and the firewall 10 when the dashmat 12 is installed in the motor vehicle.

An automotive pass-through component 16, which can comprise an HVAC unit, an electrical control box, or the like, is shown in FIGS. 2-4 mounted on the passenger side of the firewall 10 adjacent the dashmat 12. An aperture 17 is provided through the barrier layer 13 and the sound absorbing layer 14 in registry with each other and the opening 19 through the firewall 10 to enable a conduit 18, such as a fluid-conveying tube or a wiring harness, to extend from the automotive component 16 to the engine compartment when the automotive component 16 is attached to the firewall 10. As shown in FIG. 2, several openings 17, 19 can be provided for different components.

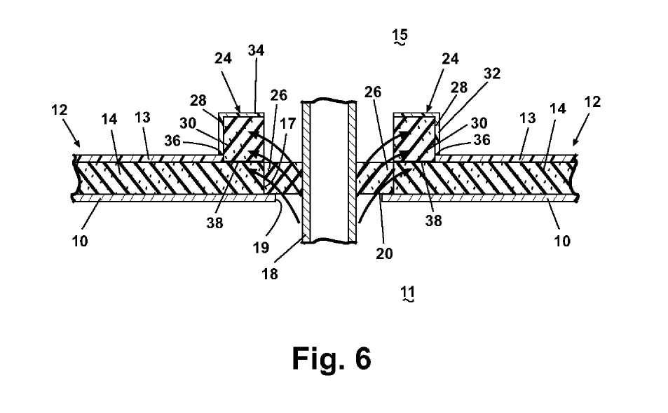

An acoustic seal 24 according to one embodiment of the invention comprises a donut-shaped annular body or collar adapted to coaxially circumscribe the aperture 19 and the conduit 18 above the surface of the barrier layer 13. As shown in FIGS. 3-5, the annular body of the acoustic seal 24 is formed in part by a sound barrier layer 28 in the form of an upwardly extending side wall 32 and an annular top wall 34 of the of the sound barrier layer 13. In a preferred embodiment, the side wall 32 and the top wall 34 are integrally formed with the barrier layer 13 although the side wall 32 and the top wall 34 can be formed separately and attached in a suitable manner to the barrier layer 13 after molding of the barrier layer 13, such as with an adhesive 36, as illustrated in FIG. 6, or other suitable fastener. Although the shape of the acoustic seal 24 is shown as donut-shaped, the configuration of the seal 24 can take many forms so long as the shape extends upwardly from the barrier layer and has an opening that extends through the body. Thus, the shape can be square, oblong, rectangular, pentagonal, hexagonal, and the like.

The acoustic seal 24 is also formed in part by an annular body 30 of a sound adsorbing material such as expanded flexible polyurethane, or a flexible fibrous material, such as a non-woven glass fiber mat, shoddy cotton, or other relatively low density, porous sound-absorbing material that is commonly employed to absorb sound and/or act as a decoupling layer. The annular body can be formed of the same material as the decoupling layer 14 or of a different material. Preferably, the annular body 30 is integrally formed with the sound absorber layer 14, although it can be separately formed and attached in a suitable manner to the sound absorber layer 14 before installation of the component 16, such as with an adhesive 38, as illustrated in FIG. 6, or other suitable fastener.

The sound barrier layer 28 is a relatively dense, resilient or flexible synthetic plastic material, such as a filled or unfilled thermoplastic elastomer, elastomer-modified polyurethanes, thermosets such as polyurethanes, or other thermoplastic materials. The acoustic seal 24 is shown in FIGS. 4 and 5 as concentrically spaced away from the conduit 18, although the acoustic seal 24 can be adapted for slidable communication with the conduit 18.

As shown in FIGS. 4 and 5, the acoustic seal 24 extends above the top surface 13a of the dashmat 12 a sufficient height to interrupt the sound, illustrated in FIG. 5 by the sound path 26, and prevent its entry into the passenger compartment. The reduction in noise is primarily a function of the height of the acoustic seal 24, rather than its concentric proximity to the conduit 18. The automotive component 16 can be positioned either in contact with the acoustic seal 24, as shown in FIG. 3, or spaced a small distance away from the acoustic seal 24 with relatively little effect on sound reduction.

It is anticipated that the acoustic seal 24 will be integrally formed with the dashmat 12 as a generally thickened portion thereof, as shown in FIG. 5. Alternatively, the acoustic seal 24 can comprise a separate element for selective installation depending upon the type and location of the automotive component(s) 16 to be installed, as shown in FIG. 6.

During vehicle assembly, the dashmat 12 will be typically installed against the firewall 10, followed at some later time by installation of the automotive component 16. The automotive component 16 will be installed by inserting the conduit 18 through the aperture 19, with the moisture seal 20 previously attached to the conduit 18 to seal the space between the conduit 18 and the aperture 19, followed by attaching the automotive component 16 to the firewall 10 through suitable conventional fasteners, as shown schematically in FIG. 3. With the acoustic seal 24 integrated with the dashmat 12, the seal 24 will be properly positioned relative to the component 16 and the conduit 18, and operable to block the transmission of sound into the passenger compartment without the necessity of a separate step for installation of the seal 24. If the acoustic seal 24 comprises a part of the dashmat 12, the conduit 18 will be inserted through the acoustic seal 24 and the aperture 19 in a single assembly step after the installation of the dashmat 12. Alternatively, with the acoustic seal 24 provided as a separate element, the acoustic seal 24 will be installed around the conduit 18 and the aperture 19 as the automotive component 16 is placed into position.

Prior art acoustic seals for controlling sound associated with firewall openings serving passenger compartment-mounted components have utilized a sound-blocking barrier layer in register with the perimeter of the component. The acoustic seal described herein provides effective sound control through an acoustic seal having both sound blocking and sound absorption properties. The acoustic seal is readily installed around the perimeter of the aperture either as a part of the dashmat or as a separate element.

While the invention has been specifically described in connection with certain specific embodiments thereof, it is to be understood that this is by way of illustration and not of limitation. For example, the invention is not limited to use of the acoustic seal with a two layer dashmat but can be used with any dashmat that has both barrier and absorption properties, including single layer firm-flexible foam. In fact, the acoustic seal can be used to attenuate sound through any opening in a substrate, regardless of the nature of the substrate. Reasonable variation and modification are possible within the scope of the foregoing description and drawings without departing from the spirit of the invention.

1. In a motor vehicle comprising a firewall extending between an engine compartment and a passenger compartment, and containing at least one opening therethrough for passage of a conduit, a sound attenuating dashmat mounted to the passenger compartment side of the firewall and having an opening in registry with the at least one opening in the firewall, and optionally, a vehicle component mounted to the firewall in the passenger compartment adjacent the openings in the firewall and the dashmat and communicating with the conduit, the improvement comprising:
an acoustic seal surrounding the openings in the firewall and the dashmat and extending upwardly from an upper surface of the dashmat toward the passenger compartment, the acoustic seal having sound absorbing and sound barrier components to attenuate sound that passes through the openings in the firewall and the dashmat and above the upper surface of the dashmat;
wherein the acoustic seal attenuates the transmission of sound from the engine compartment into the passenger compartment of the motor vehicle.

2. A motor vehicle according to claim 1, wherein the acoustic seal further comprises an upwardly extending side wall and a top wall of a sound barrier material.

3. A motor vehicle according to claim 2, wherein the sound barrier material comprises a dense, resilient, flexible synthetic plastic.

4. A motor vehicle according to claim 2, wherein the sound barrier material is selected from the group consisting of a filled thermoplastic elastomer, an unfilled thermoplastic elastomer, an elastomer-modified polyurethane, a thermoset polymer, a polyurethane, and a thermoplastic.

5. A motor vehicle according to claim 2, wherein the acoustic seal side wall is integrally formed with the sound barrier of the dashmat.

6. A motor vehicle according to claim 2, wherein the acoustic seal side wall is formed separately from the sound barrier of the dashmat.

7. A motor vehicle according to claim 1, wherein the acoustic seal further comprises an annular body of a sound absorber material.

8. A motor vehicle according to claim 7, wherein the sound absorber material comprises a low density, porous material.

9. A motor vehicle according to claim 7, wherein the sound absorber material is selected from the group consisting of an expanded flexible polyurethane, a flexible fibrous material, a non-woven glass fiber mat, and a shoddy cotton.

10. A motor vehicle according to claim 7, wherein the annular body is integrally formed with the sound absorbing layer of the dashmat.

11. A motor vehicle according to claim 7, wherein the annular body is formed separately from the sound absorbing layer of the dashmat.

12. A motor vehicle according to claim 11, wherein the annular body is fastened to the sound absorbing layer.

13. A motor vehicle according to claim 1, wherein the dashmat comprises a barrier layer and a sound absorbing layer.

14. A motor vehicle according to claim 13, wherein the barrier layer comprises a dense, resilient, flexible synthetic plastic.

15. A motor vehicle according to claim 13, wherein the barrier layer is selected from the group consisting of a barium sulfate filled polypropylene, a thermoplastic elastomer, an elastomer-modified polyurethane, a thermoset plastic, a polyurethane, and a filled thermoplastic.

16. A motor vehicle according to claim 13, wherein the sound absorbing layer comprises a foam plastic.

17. A motor vehicle according to claim 13, wherein the sound absorbing layer is selected from the group consisting of an expanded flexible polyurethane, a flexible fibrous material, a nonwoven glass fiber mat, and a shoddy cotton.

18. A motor vehicle according to claim 1, wherein the acoustic seal is in contact with the vehicle component when the vehicle component is mounted to the firewall.

19. A dashmat adapted to be mounted to a vehicle firewall separating an engine compartment and a passenger compartment, the firewall containing at least one opening therethrough for passage of a conduit, the dashmat having an opening adapted to be placed in registry with the at least one opening in the firewall, the improvement comprising:
an acoustic seal surrounding the opening in the dashmat and extending upwardly from an upper surface of the dashmat, the acoustic seal having sound absorbing and sound barrier components that are shaped and adapted to attenuate sound that passes through the opening in the dashmat;
wherein the acoustic seal is adapted to attenuate the transmission of sound from the engine compartment into the passenger compartment of the motor vehicle when the dashmat is mounted to the firewall.

20. A dashmat according to claim 19 wherein the acoustic seal further comprises an upwardly extending side wall and a top wall of a sound barrier material.

21. A dashmat according to claim 20 wherein the sound barrier material comprises a dense, resilient, flexible synthetic resin.

22. A dashmat according to claim 20 wherein the sound barrier material is selected from the group consisting of a filled thermoplastic elastomer, an unfilled thermoplastic elastomer, an elastomer-modified polyurethane, a thermoset polymer, a polyurethane, and a thermoplastic polymer.

23. A dashmat according to claim 20 wherein the dashmat includes a sound barrier layer and the acoustic seal side wall is integrally formed with the sound barrier layer of the dashmat.

24. A dashmat according to claim 20 wherein the acoustic seal side wall is formed separately from the sound barrier of the dashmat.

25. A dashmat according to claim 20 wherein the acoustic seal further comprises a sound absorber material.

26. A dashmat according to claim 25 wherein the sound absorber material comprises a low density, porous material.

27. A dashmat according to claim 25 wherein the sound absorber material is selected from the group consisting of an expanded flexible polymer, a flexible fibrous material, a non-woven glass fiber mat, and a shoddy cotton.

28. A dashmat according to claim 25 wherein the dashmat has a layer of sound adsorbing material and the acoustic seal sound absorber material is integrally formed with the sound absorbing layer of the dashmat.

29. A dashmat according to claim 25 wherein the acoustic seal sound absorber material is formed separately from the dashmat.

30. A dashmat according to claim 29 wherein the dashmat has a layer of sound adsorbing material and the acoustic seal sound absorber material is fastened to the sound absorbing layer.

31. A dashmat according to claim 19 wherein the dashmat comprises a barrier layer and a sound absorbing layer.

32. A dashmat according to claim 31 wherein the barrier layer comprises a dense, resilient, flexible synthetic plastic.

33. A dashmat according to claim 31 wherein the barrier layer is selected from the group consisting of a barium sulfate filled polypropylene, a thermoplastic elastomer, an elastomer-modified polyurethane, a thermoset plastic, a polyurethane, and a filled thermoplastic.

34. A dashmat according to claim 31 wherein the sound absorbing layer comprises a foam plastic.

35. A dashmat according to claim 31 wherein the sound absorbing layer is selected from the group consisting of an expanded flexible polyurethane, a flexible fibrous material, a nonwoven glass fiber mat, and a shoddy cotton.

36. A dashmat according to claim 19 wherein the acoustic seal further comprises a sound absorber material.

37. A dashmat according to claim 36 wherein the sound absorber material comprises a low density, porous material.

38. A dashmat according to claim 37 wherein the sound absorber material is selected from the group consisting of an expanded flexible polymer, a flexible fibrous material, a non-woven glass fiber mat, and a shoddy cotton.

39. A dashmat according to claim 36 wherein the dashmat has a layer of sound adsorbing material and the acoustic seal sound absorber material is integrally formed with the sound absorbing layer of the dashmat.

40. A dashmat according to claim 36 wherein the acoustic seal sound absorber material is formed separately from the dashmat.

41. A dashmat according to claim 40 wherein the dashmat has a layer of sound adsorbing material and the acoustic seal sound absorber material is fastened to the sound absorbing layer.

42. An acoustic seal for surrounding an opening in a substrate having an obverse surface and a reverse surface, and the acoustic seal extends outwardly from the obverse surface of the substrate;
wherein the acoustic seal has sound absorbing and sound barrier characteristics to attenuate sound that passes through the opening in the substrate and above the obverse surface of the substrate;
whereby the acoustic seal interrupts the transmission of sound through the opening in the substrate from the obverse side of the substrate.

43. An acoustic seal according to claim 42 wherein the acoustic seal further comprises an upwardly extending side wall and a top wall formed of a sound barrier material and the top wall has an opening therein.

44. An acoustic seal according to claim 43 wherein the sound barrier material comprises a dense, resilient, flexible synthetic plastic.

45. An acoustic seal according to claim 43 wherein the sound barrier material is selected from the group consisting of a filled thermoplastic elastomer, an unfilled thermoplastic elastomer, an elastomer-modified polyurethane, a thermoset plastic, a polyurethane, and a thermoplastic.

46. An acoustic seal according to claim 43 wherein the acoustic seal side wall is integrally formed with the substrate.

47. An acoustic seal according to claim 43 wherein the acoustic seal side wall is formed separately from the substrate.

48. An acoustic seal according to claim 42 wherein the acoustic seal further comprises a sound absorber material.

49. An acoustic seal according to claim 48 wherein the sound absorber material comprises a low density, porous material.

50. An acoustic seal according to claim 48 wherein the sound absorber material is selected from the group consisting of expanded flexible polymer, a flexible fibrous material, a non-woven glass fiber mat, and a shoddy cotton.

51. An acoustic seal according to claim 48 wherein the sound absorber material is integrally formed with the substrate.

52. An acoustic seal according to claim 48 wherein the sound absorber material is formed separately from the substrate.

53. An acoustic seal according to claim 47 wherein the sound absorber material is fastened to the substrate.
